(19) United States
(12) Patent Application Publication
(10) Pub. No.: US 2013/0018567 A1
(43) Pub. Date: Jan. 17, 2013

(54) MOBILE TERMINAL, SYSTEM AND METHOD FOR CONTROLLING AN ELECTRONIC CONTROL UNIT

(71) Applicants: Sang Woo LIM, Seoul (KR); Seung Hyun LEE, Seoul (KR); In Oh HWANG, Seoul (KR)

(72) Inventors: Sang Woo LIM, Seoul (KR); Seung Hyun LEE, Seoul (KR); In Oh HWANG, Seoul (KR)

(73) Assignee: PANTECH CO., LTD., Seoul (KR)

(21) Appl. No.: 13/313,073

(22) Filed: Dec. 7, 2011

(30) Foreign Application Priority Data
Jul. 12, 2011 (KR) 10-2011-0068920

(51) Int. Cl. F02D 28/00

(52) U.S. Cl. 701/102

(57) ABSTRACT

A mobile terminal to control an Electronic Control Unit (ECU) of a vehicle includes a communication unit, a storage unit, and an ECU control unit. The communication unit communicates with the ECU, and the storage unit stores information collected from the ECU and status information collected inside or outside the mobile terminal. The ECU control unit determines a driving environment of the vehicle according to the status information collected, processes the information collected from the ECU, and controls the ECU. A method for controlling a vehicle ECU from a mobile terminal includes determining a driving environment, and remotely controlling the ECU from the mobile terminal based on the driving environment.

### CROSS-REFERENCE TO RELATED APPLICATION

This application claims priority from and benefit under 35 U.S.C. §119(a) of Korean Patent Application No. 10-2011-0068920, filed on Jul. 12, 2011, which is incorporate by reference for all purposes as if fully set forth herein.

### BACKGROUND

1. Field

This disclosure relates to a mobile terminal and a system and a method for controlling an electronic control unit (ECU) of a vehicle using the same, and more particularly, to a mobile terminal to control an ECU of a vehicle on the basis of information which may be collected by the mobile terminal and a system and a method for controlling an ECU of a vehicle using the same.

2. Discussion of the Background

An electronic control unit (ECU) is a device that receives signals from various sensors, calculates an ECU value for controlling a system, and transmits a control signal to a corresponding actuator.

Initially, the ECU of the vehicle was aimed to precisely control a key operation, such as ignition timing, a fuel injection, an adjustment of a fuel amount, an idle rotation, a rail pressure control, a torque control, an exhaust gas circulation control, and a boost pressure control. However, nowadays, the ECU may be implemented to control many parts of the vehicle, such as a driving system, a braking system, and a steering system, with the advanced performance of the vehicle and a computer.

For example, in the engine control, an ignition timing Manifold Absolute Pressure (MAP) value, a fuel injection MAP value, and the like may be determined in advance and matched with an engine RPM, an air intake amount, an intake pressure, an accelerator opening degree, and the like, which are searched for and used to correct a water temperature sensor, an oxygen sensor, and the like and to adjust an opening and closing rate of an injector. Thus, to achieve this, a fuel injection amount and the ignition timing may be determined.

In the ECU of the vehicle, an initial ECU value is set for each item so as to prevent damage of an engine, after which, a value ascertained during a driving state may also be stored.

Further, as disclosed in Korean Patent Application-Laid Open No. 10-2007-0076201, a technology has been developed which updates a ROM program of an electronic control device inside a vehicle using a personal terminal of a driver.

However, since the driving environment of the vehicle frequently changes, an ECU value that does not adjust with the changes may not be optimal. Further, if a plurality of drivers share and operate a vehicle, the ECU value may not be optimal for a specific driver, if set for another driver.

### SUMMARY

The present disclosure provides a mobile terminal to controlling an ECU of a vehicle, may improve fuel efficiency and performance of the vehicle.

Additional features of the invention will be set forth in the description which follows, and in part will be apparent from the description, or may be learned by practice of the invention.

An exemplary embodiment provides a mobile terminal to control an electronic control unit (ECU), including: an ECU control unit to remotely control the ECU; and a communication unit to communicate with the ECU; wherein the ECU control unit controls the ECU based on a driving environment.

An exemplary embodiment provides a method for controlling an electronic control unit (ECU) from a mobile terminal, including: determining a driving environment; and remotely controlling the ECU from the mobile terminal based on the driving environment.

An exemplary embodiment provides an electronic control unit (ECU) of a vehicle, the ECU including: a central processing unit (CPU) to control the ECU; and a communication unit to communicate remotely with a device that stores control information, wherein the CPU controls the ECU based on the control information.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an ECU control system according to an exemplary embodiment.

FIG. 2 is a block diagram illustrating the ECU control system according to an exemplary embodiment.

FIG. 3 illustrates data stored in a storage unit of an ECU according to an exemplary embodiment.

FIG. 4 illustrates status information collected inside or outside a mobile terminal according to an exemplary embodiment.

FIG. 5 is a block diagram illustrating the ECU control unit according to an exemplary embodiment.

FIG. 6 illustrates controlling in accordance with a mode of the vehicle according to an exemplary embodiment.

FIG. 7 is an example illustrating a controller area network (CAN) communication protocol between an ECU control unit and the ECU according to an exemplary embodiment.

FIG. 8 is a block diagram illustrating the ECU control unit of the mobile terminal according to an exemplary embodiment.

FIG. 9 is a block diagram illustrating the ECU control unit according to an exemplary embodiment.

FIG. 10 is a flowchart illustrating a method for controlling the ECU according to an exemplary embodiment.

FIG. 11 is a flowchart illustrating a method for controlling the ECU according to an exemplary embodiment.

FIG. 12 is a flowchart illustrating a method for controlling the ECU according to an exemplary embodiment.

FIG. 13 is a flowchart illustrating a method for controlling the ECU according to an exemplary embodiment.

FIG. 14 is a flowchart illustrating a method for controlling the ECU according to an exemplary embodiment.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms including technical and scientific terms used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

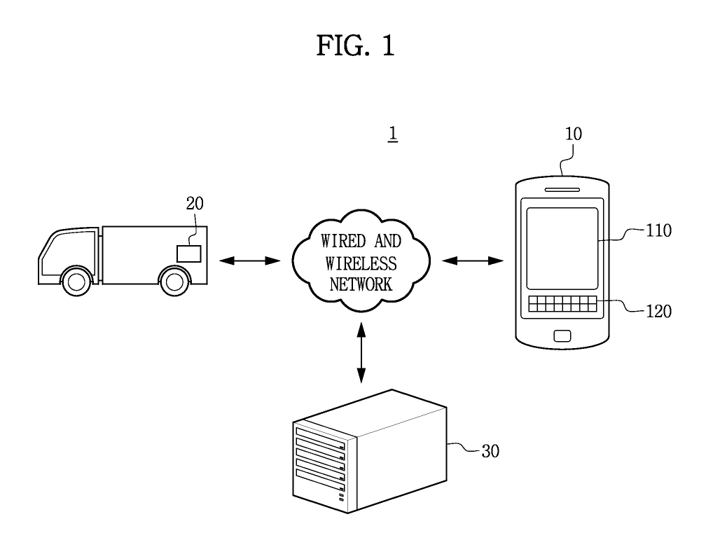

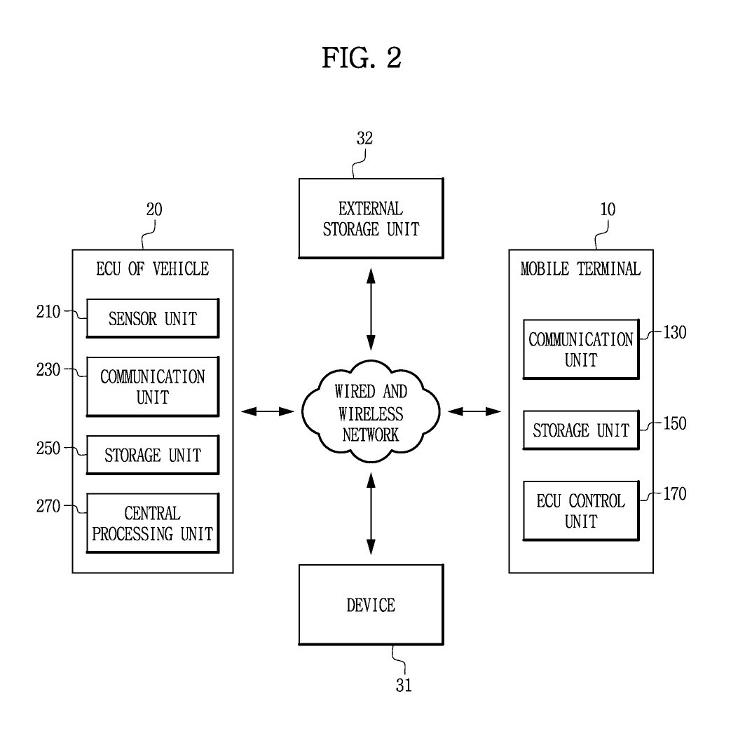

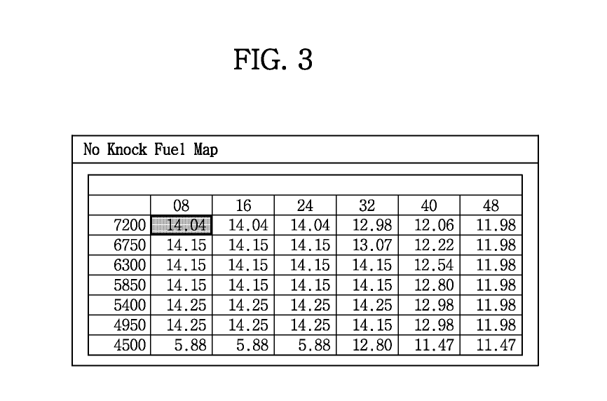

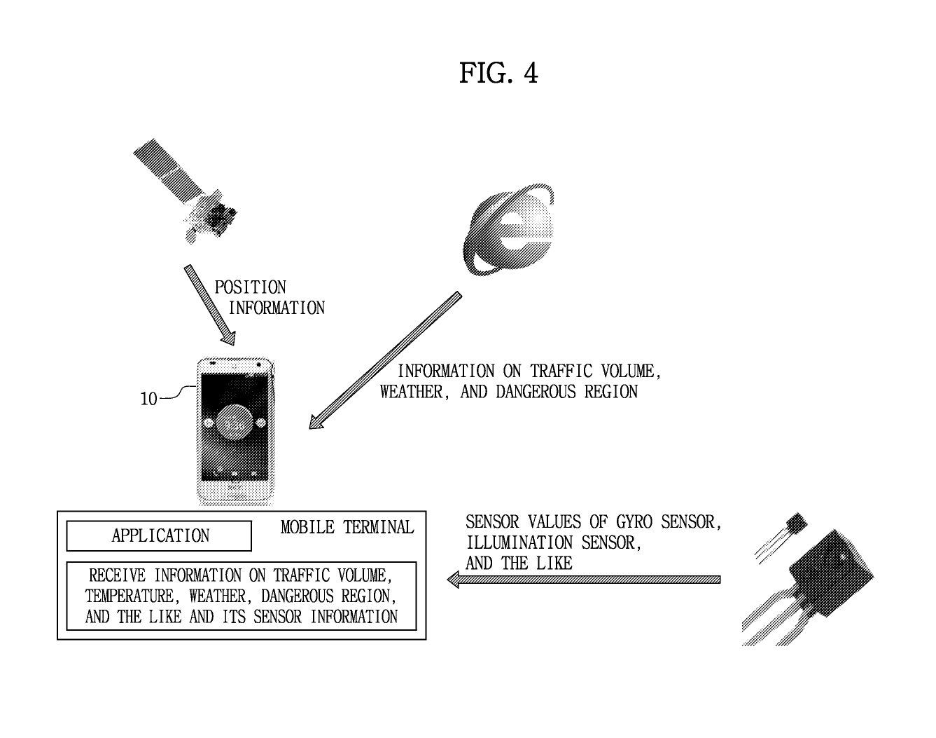

FIG. 1 is a diagram illustrating an ECU control system according to an exemplary embodiment. FIG. 2 is a block diagram illustrating the ECU control system according to an exemplary embodiment. FIG. 3 illustrates data stored in a storage unit of an ECU according to an exemplary embodiment. FIG. 4 illustrates status information collected inside or outside a mobile terminal according to an exemplary embodiment.

Referring to FIG. 1 and FIG. 2, an ECU control system of a vehicle 1 includes a mobile terminal 10, an ECU 20 of the vehicle, and a peripheral device 30. In the ECU control system 1, the ECU 20 of the vehicle is controlled through the mobile terminal 10.

The ECU 20 is an electronic control device that may control all, or some, parts of the vehicle, such as a driving system, a braking system, and a steering system in addition to an engine. For example, the ECU 20 may adjust the amount of fuel in accordance with the amount of air input to the engine or adjust the amount of fuel by inputting more fuel when the engine is not warmed up yet.

Further, the ECU 20 may delay the ignition timing if a knocking phenomenon is caused by the early ignition timing at the compressing stage. Further, the ECU 20 of the vehicle may adjust the engine RPM in a stop state to adjust the idle speed. Also, a variable valve timing called a VVT may be adjusted by adjusting the amount of air input to a cylinder through a valve adjustment.

The ECU 20 includes a sensor unit 210, a communication unit 230, a storage unit 250, and a central processing unit 270.

The sensor unit 210 includes a sensor attached to the vehicle. For example, the sensor unit 210 may include various sensors, such as a speed sensor, a steering sensor, a wheel sensor, and a temperature sensor. The sensor unit 210 may measure the speed of the vehicle, the running direction, the engine RPM, the air intake amount, and the engine temperature, and provides the measurement information for the central processing unit 270.

The communication unit 230 communicates with a wireless or wired connection with the mobile terminal 10 or another device 31. For example, the communication unit 230 may communicate with the mobile terminal 10 or another device 31 through various methods, such as a wireless LAN communication method, a data communication method, and a USB cable communication method.

The storage unit 250 stores a numerical value of ECU values as initial data for respective items to control the vehicle and an ECU value which is ascertained during a driving state. Thus, the ECU value is initially set or selected, but may be changed in accordance with the running state of the vehicle.

Further, the ECU value may be changed based on the driving habits of the driver. For example, the ECU value may be changed in accordance with a change caused by the driver, such as a driving pattern, a vehicle speed, and an accelerator pressing degree. Here, the driver is defined an operator or driver of a vehicle.

Specifically, the ECU value stored in the storage unit 250 indicates a numerical value for an engine control and a limitation value thereof, and includes, for example, an engine RPM, an intake air amount, a intake pressure, and an accelerator opening degree.

Referring to FIG. 3, an example of the ECU value stored in the storage unit 250 is provided. Specifically, there is a lookup table which may be selectively corrected in accordance with a selection and preference of a user, and numerical values may also be input. The ECU value may have a parameter for the ranges of data that may be stored, such as being stored by a unit of 1 byte (B), and may have 256 KB at minimum and 2 MB or more at maximum. Specific numbers are provided herein; however, aspects of this disclosure are not limited thereto.

The storage unit 250 may store an ECU value according to a sports mode, a comfort mode, an ECO mode, and a driver setting mode in accordance with the type of the vehicle. For example, if the vehicle is a sports car, the stored ECU value may be an ECU value suitable for the sports car. If the vehicle is a comfort car, the stored ECU value may be an ECU value suitable for the comfort car.

Further, the storage unit 250 may store all ECU values in accordance with various modes of the vehicle. In this case, the ECU value may be changed and applied for each mode in accordance with the selection of the driver.

The storage unit 250 may include at least one of: a flash memory type memory, a hard disk type memory, a multimedia card micro type memory, a card type memory, a random access memory (RAM), an static random access memory (SRAM), a read-only memory (ROM), a programmable read-only memory (PROM), an erasable programmable read-only memory (EPROM), an electrically erasable programmable read-only memory (EEPROM), a magnetic memory, a magnetic disk, and an optical disc.

The storage unit 250 may include a first memory to store initial data as the fixed ECU value and a second memory to store the changed ECU value. For example, the first memory may be an EPROM or an EEPROM, and the second memory may be a RAM or an EEPROM.

Hereinafter, for the purpose of this disclosure, the ECU value as the initial data and the ECU value learned during the driving state may be referred to as basic data.

The central processing unit 270 controls the vehicle on the basis of the basic data stored in the storage unit 250 and various information items provided from the sensor unit 210. Further, the central processing unit 270 may further use external information provided from the mobile terminal 10 or another device 31 through the communication unit 230.

For example, the central processing unit 270 may generate various control signals to control an engine, a transmission, an anti-lock brake system (ABS), a door, a roof, an electric seat, an interior lamp, a power window, an audio, a video, an internet, a navigation, and the like of the vehicle.

The central processing unit 270 may generate the control signals for a specific mode of operating the vehicle, such as a sports mode, a comfort mode, an ECO mode, and a driver setting mode of the vehicle. The central processing unit 270 may use software and/or hardware that processes and calculates the data of the vehicle. The software may be based on the standard defined in the Open Systems and the Corresponding Interfaces for Automotive Electronics/Vehicle Distributed eXecutive (OSEK/VDX), the Association for Standardizations of Automation and Measuring Systems (ASAM), and the like.

The peripheral device 30 may be another device 31 or an external storage unit 32. For example, the external storage unit 32 may be an external database or a web server providing a cloud service. In other examples, the other device 31 may be a mobile terminal or any other device capable of interfacing with the ECU 20. In the example provided above, and the figure referenced to, a single secondary device is shown; however, aspects of this disclosure are not limited to a single device and may incorporate multiple secondary devices.

Another device 31 shares information via a wireless and/or wired network with the mobile terminal 10. The device 31 may directly provide information for the ECU 20 via a wireless or wired communication.

The ECU 20 stores basic data for each item, with the basic data being used to control the vehicle. However, due to driving status changes that may be caused by various reasons, such as a irregular degree of a vehicle, a driving habit of a driver, a vehicle state, a traffic volume, a weather, and a dangerous region, the basic data may be corrected to match the status being changed to.

Further, if another driver shares one vehicle, the basic data may be adjusted in accordance with a style associated with each driver.

In the disclosure, the basic data stored in the ECU 20 is mapped with the mobile terminal 10 carried by the driver of the vehicle. An optimal value may be calculated by using information which may be collected by the mobile terminal 10. Thus, the ECU 20 may obtain information about a driver of the vehicle through information obtained from the mobile terminal 10, to produce an optimal value for controlling various operations of the vehicle.

The mobile terminal 10 includes a communication unit 130, a storage unit 150, and an ECU control unit 170. The mobile terminal 10 may further include a display unit 110 (not shown) that displays information processed by the mobile terminal 10, and an input unit 120 (not shown) in which information is input by the user.

The display unit 110 may include at least one of: a liquid crystal display (LCD), a thin film transistor-liquid crystal display (TFT-LCD), an organic light-emitting diode display (OLED), a flexible display, and a 3D display.

The input unit 120 allows the user to input information and includes characters and numbers. The input unit 120 may include pads that are separate from the display unit 110. Here, the user is defined as a person who uses the mobile terminal 10. The user of the mobile terminal 10 may also be the same person as the driver of the vehicle.

The input unit 120 may be displayed on the display unit 110, and the display unit 110 may include a touch panel and simultaneously perform an input function and a display function.

The touch panel may receive an external signal, such as a change in pressure applied to a surface of the touch panel or a change in electrostatic capacitance generated at a specific portion which is converted into an electrical input signal through a touch sensor. The touch sensor may be provided in the form of a touch film, a touch sheet, a touch pad, or the like. The touch sensor may detect a touching pressure and a movement of a touched object, in addition to the touching position and area.

The communication unit 130 communicates with the ECU 20 and peripheral device 30 via a wired or wireless connection. The communication unit 130 may communicate with the ECU 20 or peripheral device 30 through various methods, such as, a wireless LAN method such as a wireless fidelity (Wi-Fi®), a wireless broadband (WiBro®), and a world interoperability for microwave access (WiMAX®), and/or a data communication method, such as a wide code division multiple access (WCDMA®), a high speed downlink packet access (HSDPA®), and a USB cable communication method.

The communication unit 130 may be a wireless interface that performs a wireless communication with an external device. The ECU 20 and the mobile terminal 10 may communicate with each other through a wired communication method, and specifically, may be connected to each other through an onboard diagnostic (ODB-II) connector using wired communication.

The mobile terminal 10 may control the ECU 20 through the communication with the ECU 20, and may share information stored in another device 31 through the communication with peripheral device 30.

The mobile terminal 10 may share the information with peripheral device 30 through at least one of: a short message service (SMS), a multimedia message service (MMS), a website share, and a peer-to-peer (P2P).

The storage unit 150 may store information collected from the ECU 20 and the status information collected inside or outside the mobile terminal 10. Further, the status information collected inside or outside the mobile terminal 10 may include information input by the user. Thus, the status information may be associated with the mobile terminal 10, such as, an environment in which the mobile terminal 10 is in, a specific setting associated with the mobile terminal 10 or the user of the mobile terminal 10, and an input to the mobile terminal 10.

The storage unit 150 may be an SD card or a memory attached to the mobile terminal 10. The storage unit 150 may be an external web server of the mobile terminal 10.

The information collected from the ECU 20 and the status information may be updated in real time or at an interval. Further, the user may set the interval, and the status information may be updated in accordance with the user's setting.

The status information of the mobile terminal 10 may include status information stored in another device 31 or an external storage unit 32 that communicates with the mobile terminal 10.

Referring to FIG. 4, the mobile terminal 10 may use various status information items, which may be collected externally.

For example, the status information of the mobile terminal 10 may include various information, such as a time, a current traffic volume, weather, road information, a slope of a vehicle stop position, an oxygen amount, and a dangerous region. Further, the status information may include position information of the vehicle, which may be collected by a global positioning system (GPS) or another position ascertaining device.

Further, the status information of the mobile terminal 10 may include information provided from at least one of a gyro sensor and/or an illumination sensor attached to the mobile terminal 10.

The information collected from the ECU 20 may include at least one of: the basic data stored in the ECU 20 and sensor information provided from the sensor unit 210 attached to the vehicle.

The information collected from the ECU 20 may include at least one of: information of a driving pattern of a driver, vehicle speed, an accelerator pressing degree, a seat position, and a side mirror position. The information may be individually collected in accordance with each user driving the vehicle. Further, the information may include information, such as numerical or other values that are input by the user.

The collected status information may be accumulated for each status, and may be separately stored in the storage unit 150. For example, in the case of the time, status information associated with various times, such as rush-hour, weekday morning, weekday afternoon, weekend morning, weekend afternoon and the like, may be matched with basic data of the vehicle collected at the time, and may be accumulated and stored in the form of a lookup table.

If the status information pertains to weather, the status information may be associated with at least one of: a clear day, rainy day, and/or the snowy day, and may be matched with basic data, therefore being accumulated and stored in the form of a lookup table.

If the status information pertains to road information, the status information may be associated with at least one of: the national highway, the general national road, the special city road, the local road, and the like, and may be accumulated and stored in the form of a lookup table.

If the status information is related to various drivers, such as a driver A and driver B, the status information may be accumulated according to the driving state of each driver, and may be stored in the form of a lookup table. The ECU control unit 170 may distinguish the driver on the basis of a number or information associated with the mobile terminal 10, and/or an input of the user.

For example, if the user gets in the vehicle with the mobile terminal 10 used by the user, the user may input his or her information by connecting the mobile terminal 10 to the vehicle.

The ECU control unit 170 controls the ECU 20 on the basis of information stored in the storage unit 150. The ECU control unit 170 may control the ECU 20 to calculate the setting data mapped in the ECU 20 on the basis of stored information, or control the ECU 20 by providing status information stored in the ECU 20.

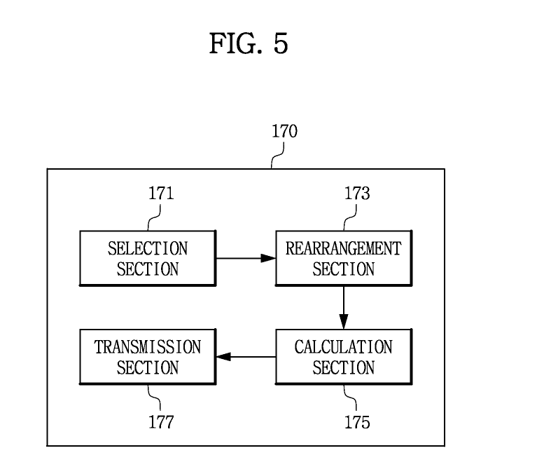

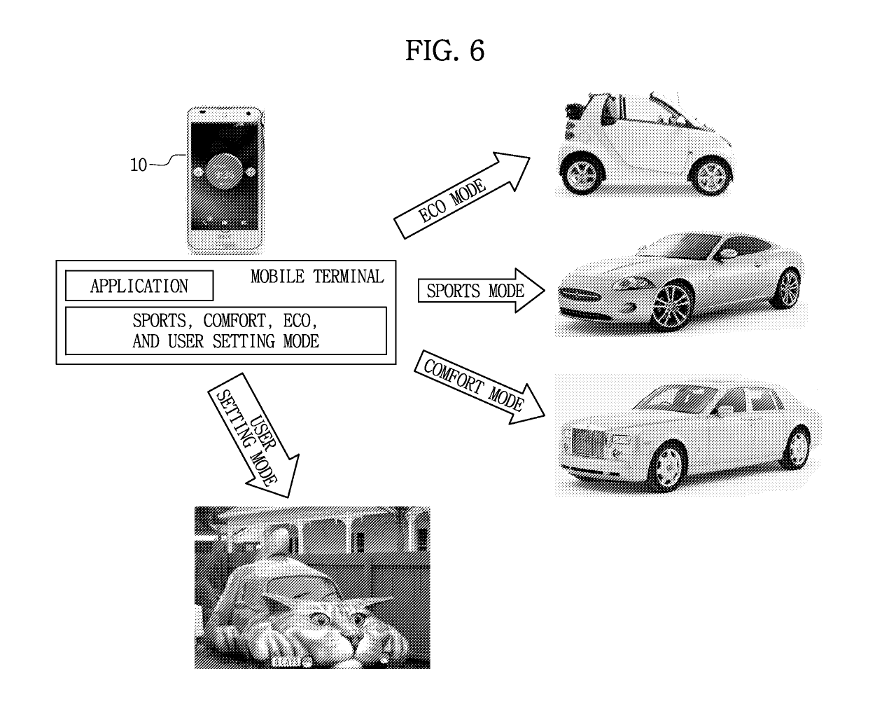

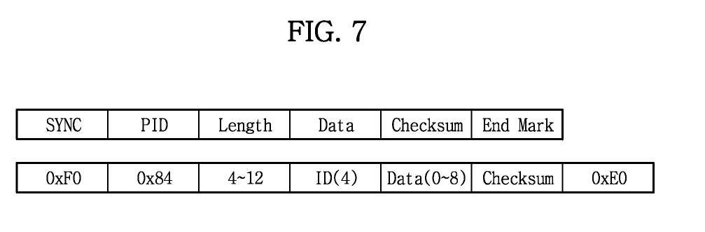

FIG. 5 is a block diagram illustrating the ECU control unit according to an exemplary embodiment. FIG. 6 illustrates control in accordance with a mode of the vehicle according to an exemplary embodiment. FIG. 7 is an example illustrating a controller area network (CAN) communication protocol between an ECU control unit and the ECU according to an exemplary embodiment.

Referring to FIG. 5, the ECU control unit 170 includes a selection section 171, a rearrangement section 173, a calculation section 175, and/or a transmission section 177.

The selection section 171 selects each status information item in accordance with a current driving environment from the storage unit 150. For example, when the current time is a weekday quitting time, such as 7 pm on Monday, the accumulated status information corresponding to a weekday rush-hour, stored in the storage unit 150 is selected. When the current weather is rainy weather, the accumulated status information corresponding to a rainy day, stored in the storage unit 150 is selected. In the case of the slope of the vehicle stop position, the accumulated status information corresponding to a sloped road is selected. When the driver driving the current vehicle is the driver A, the accumulated status information corresponding to driver A is selected.

The selection section 171 may select any one of the following status information items pertaining to vehicle modes, such as the sports mode, the comfort mode, the ECO mode, and the user setting mode. For example, if the driver of the vehicle selects a sports mode, the selection section 171 may select status information pertaining to the sports mode. If the driver selects the comfort mode, the selection section 171 may select status information pertaining to the comfort mode.

The vehicle mode may be automatically determined based on the type of the vehicle, or may be determined based on the input of the user.

The rearrangement section 173 rearranges the status information selected by the selection section. The rearrangement section 173 matches the status information selected by the selection section 171 with the information collected from the ECU based on the status. The rearrangement section 173 may rearrange the matched information to be stored in the form of a new lookup table.

For example, in the above-described case, status information associated with the weekday rush-hour, the rainy day, the sloped road, and the driver A may be rearranged and stored.

The calculation section 175 calculates the setting data mapped to the ECU 20 on the basis of the rearranged information. The ECU control unit 170 may calculate the setting data by using software and/or hardware that is stored in the ECU control unit 170 or obtained from another source, such as another device 31 or external device 32.

The setting data calculated by the ECU control unit 170 may be an optimal ECU value to control the vehicle based on the current driving state, and/or the selected status. That is, the optimal value may provide settings that meet or exceed threshold values for the fuel efficiency, the performance, and the safety of the vehicle.

The ECU control unit 170 may select any one of the status information items, such as the sports mode, the comfort mode, the ECO mode, and the user setting mode based on a type of the running mode selected by the selection section 171.

Referring to FIG. 6, the ECU control unit 170 may provide the calculated setting data in accordance with the vehicle mode.

The transmission section 177 transmits the calculated setting data to the ECU 20. If setting data is transmitted, the ECU 20 may replace the stored basic data with the calculated setting data.

For example, the ECU control unit 170 and the ECU 20 may be connected to each other through an ODB-II connector, and may use a controller area network (CAN) communication protocol. Referring to FIG. 7, the CAN communication protocol may include a SYNC field, a PID field, a length field, a data field, a checksum field, and an end mark field.

The SYNC field indicates the start of the packet, the value is fixed to 0xF0, and the size of the packet may be 1 byte (B). The PID field indicates a packet ID, and is transmitted subsequently after the SYNC field, and the size thereof may be 1 B. A size of 1 B is used in the exampled disclosed herein; however, various sizes may be used.

The packet ID indicates a special code given to perform a special function of the packet, and no data may be present or eight data items may be present. For example, if the data of the PID field is 0x80, the CAN controller may be initialized. If the data is 0x84, data may be transmitted to the CAN. If the data is 0x85, data may be received from the CAN.

The length field indicates the length of the data by the byte, and the size thereof may be 1 B. The size of the data field is from 0 to 255 B, and when the value of the data field is a format of a word (2 B) or a double word (4 B). Each byte may be ranked, with the low-rank byte being transmitted first.

In the checksum field, the sum from the PID field to the data field is set to 1 B. The end mark field indicates the end of the packet, the value is fixed to 0xE0, and the size thereof may be 1 B.

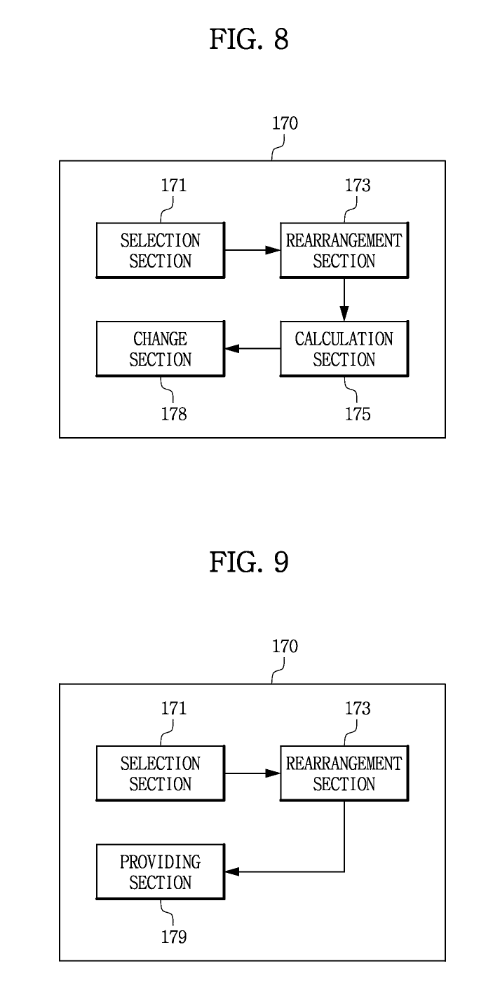

FIG. 8 is a block diagram illustrating the ECU control unit of the mobile terminal according to an exemplary embodiment.

Referring to FIG. 8, the ECU control unit 170 includes the selection section 171, the rearrangement section 173, the calculation section 175, and a change section 178. Since the selection section 171, the rearrangement section 173, and the calculation section 175 of FIG. 8 are similar to those of FIG. 5, the description will be omitted.

The change section 178 changes the basic data storied in the ECU 20 of the vehicle to the setting data. For example, the ECU control unit 170 may advance to the storage unit 240 of the ECU 20 through a background debug mode (BDM) method, delete the basic data by using a ROM writer, and input the setting data.

The calculated setting data may be provided to the ECU 20, but also may be shared with peripheral device 30. Accordingly, the user or the like of peripheral device 30may control the ECU of the vehicle by using the setting data.

The setting data may be stored in the external storage unit 32, and the user of the another device 31 may download the setting data to his or her mobile terminal through a connection to the external storage unit 32.

Accordingly, the basic data stored in the ECU 20 may be mapped to an optimal value by using the information which may be collected by the mobile terminal 10.

The mobile terminal 10 may control the ECU 20 through various operations. For example, if the vehicle approaches a dangerous region, the maximum safe speed in the dangerous region may be calculated from the setting data. Accordingly, in the case of emergency, a third organization such as a police department, a military department, and a command office may regulate a vehicle running at a specific region or a specific speed.

In addition, auto theft may be prevented by controlling the vehicle, so that the vehicle may not move without the mobile terminal 10 being present. The setting data may be calculated in accordance with the emission standard applied to a diesel passenger car in the European Union such as Euro 4 or Euro 5.

FIG. 9 is a block diagram illustrating the ECU control unit according to an exemplary embodiment.

Referring to FIG. 9, the ECU control unit 170 includes the selection section 171, the rearrangement section 173, and a providing section 179. Since the selection section 171 and the rearrangement section 173 of FIG. 9 are similar as those of FIG. 5, the description will be omitted.

The providing section 179 provides status information that has been rearranged by the rearrangement section 173 for the ECU 20. The ECU control unit 170 of FIG. 9 does not calculate the setting data differently from the ECU control unit of FIG. 5 and FIG. 8, but provides status information in accordance with the current driving environment. In this case, the setting data may be calculated on the basis of the provided status information at the ECU 20.

The respective status information items selected by the selection section 171 is rearranged in the rearrangement section 173, is stored, and is provided to the ECU 20. However, a rearrangement section 173 may not be provided, and in this case, the respective status information items selected by the selection section 171 may be directly provided to the ECU 20 via the providing section 179.

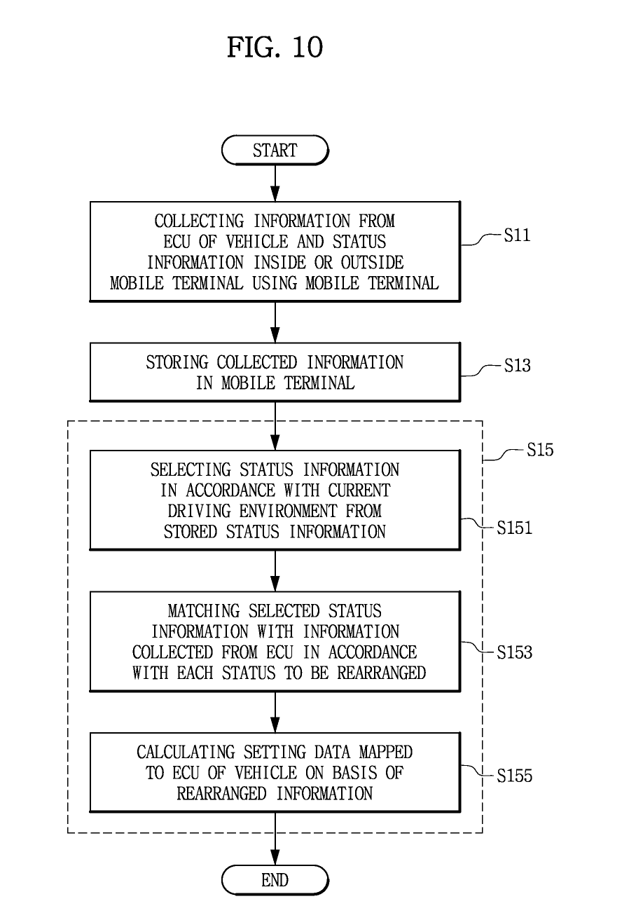

FIG. 10 is a flowchart illustrating a method for controlling the ECU according to an exemplary embodiment.

Referring to FIG. 10, the mobile terminal collects information pertaining to the ECU 20 and status information of the mobile terminal (S11).

The status information of the mobile terminal 10 may include the status information stored in another mobile terminal 31 or an external storage unit 32, both or either of which may communicate with the mobile terminal 10.

Status information collected of the mobile terminal 10 may include various details, such as a time, a current traffic volume, weather, road information, a slope of a vehicle stop position, an oxygen amount, and/or a dangerous region. Further, status information may include position information of the vehicle collected by a GPS or a position ascertaining device.

Further, status information collected of the mobile terminal 10 may include information provided from at least one of: a gyro sensor, an illumination sensor, and/or the like, the sensor being attached to the mobile terminal 10.

The information collected from the ECU 20 may include at least one of: basic data stored in the ECU 20 of and/or sensor information provided from the sensor unit 210 attached to the vehicle.

The information collected from the ECU 20 may include at least one of: information pertains to a driving pattern of a driver, a vehicle speed, an accelerator pressing degree, a seat position, and a side mirror position. The information may be individually collected in accordance with each user driving the vehicle. Further, the information may include information such as numerical or other types of value directly input by the user and a mode of the vehicle selected by the user.

The collected information and status information are stored in the mobile terminal (S13).

The storage unit 150 may store the information collected from the ECU 20 and status information collected of the mobile terminal 10. Further, status information collected of the mobile terminal 10 may include information collected by the user. The collected status information may be accumulated for each status, and may be stored in the storage unit 150 in the form of a lookup table.

The storage unit 150 may be an SD card or a memory attached to the mobile terminal 10. The storage unit 150 may be an external web server of the mobile terminal 10.

The information collected from the ECU 20 and status information collected inside or outside the mobile terminal 10 may be updated in real time or at a specific interval. Further, the user may set an update interval, with status information being updated in accordance with the user's setting.

The collected status information may be accumulated for each status, and may be separately stored in the storage unit 150. For example, if the status information pertains to time, and specifically is one of the following: the rush-hour, the weekday morning, the weekday afternoon, the weekend morning, and the weekend afternoon, and this information may be matched with the basic data of the vehicle collected at that time, and may be accumulated to be stored in the form of a lookup table. If the information pertains to the weather, the status information may be one of the following: a clear day, a rainy day, and a snowy day; and this information may be matched with the basic data, and may be accumulated and stored.

The status in accordance with the vehicle driving environment may be distinguished according to the status information collected of the mobile terminal 10, and the information collected from the ECU 20 for each status may be processed to generate data capable of controlling the ECU 20 (S15).

The ECU control unit 170 controls the ECU 20 on the basis of the information stored in the storage unit 150. The ECU control unit 170 may calculate the setting data mapped to the ECU 20 on the basis of the stored information or control the ECU 20 by providing this stored information.

The generating of the data capable of controlling vehicle ECU 20 (S15) includes selecting the status information in accordance with the current driving environment from the stored status information (S151), matching the selected status information with the information collected from the ECU 20 in accordance with each status so as to be rearranged (S153), and calculating the setting data mapped to the ECU 20 on the basis of the rearranged information (S155).

The selecting of status information in accordance with the current driving environment (S151) entails selecting one of status information of a specific mode, such as a sports mode, comfort mode, economic (ECO) mode, and a user setting mode, the mode corresponding to a running mode selected for the vehicle. For example, if the driver in the vehicle selects the sports mode, the selection section 171 may select status information suitable for the sports mode. If the driver selects the comfort mode, the selection section 171 may select only the status information suitable for the comfort mode.

The vehicle mode may be automatically determined in accordance with the type of the vehicle, or may be determined in accordance with an input of the user.

The rearranging the selected status information (S153) rearranges and stores the status information in accordance with the current status. For example, the selected status information may be rearranged and stored in the form of a new lookup table.

The calculating the setting data (S155) may calculate the setting data by using software and/or hardware.

The calculated setting data may be the optimal ECU value for controlling the vehicle in accordance with the current driving state. That is, the optimal value may provide fuel efficiency, performance, and the safety of the vehicle according to predetermined thresholds or within a range of those thresholds.

The ECU control unit 170 may calculate the setting data in accordance with a specific driving environment. For example, if a driver of a vehicle drives at specific time and condition, such as the weekday rush-hour on a rainy day on a sloped road, the accumulated information based on those factors corresponding to respective components of status information stored in the storage unit 150 may be used in combination.

The generating of data capable of controlling the ECU 20 (S15) may further include transmitting the calculated setting data to the ECU 20. If the setting data is transmitted, the ECU 20 may replace the stored basic data with the setting data.

The generating of data capable of controlling the ECU 20 (S15) may further include directly changing the basic data stored in the ECU 20 for setting data. For example, the ECU control unit 170 may directly advance to the storage unit 240 of the ECU 20 through a background debug mode (BDM) method, delete the basic data by using a ROM writer, and input the setting data.

The calculated setting data may be provided to the ECU 20, but also may be shared with peripheral device 30, which may be another device 31. Accordingly, the user or the like of the other device 31 may control the ECU 20 by using the calculated setting data.

The setting data may be stored in the external storage unit 32, and the user of another device 31 may download the setting data to his or her mobile terminal via a connection to the external storage unit 32.

The generating of data capable of controlling the ECU 20 (S15) may include selecting the status information with the current driving environment from the stored status information and providing the selected status information for the ECU 20. Further, operation S15 may further include rearranging the selected status information. The ECU 20 may calculate the setting data in accordance with the driving environment.

Accordingly, the basic data stored in the ECU 20 may be mapped to an optimal value by using the information collected by the mobile terminal 10.

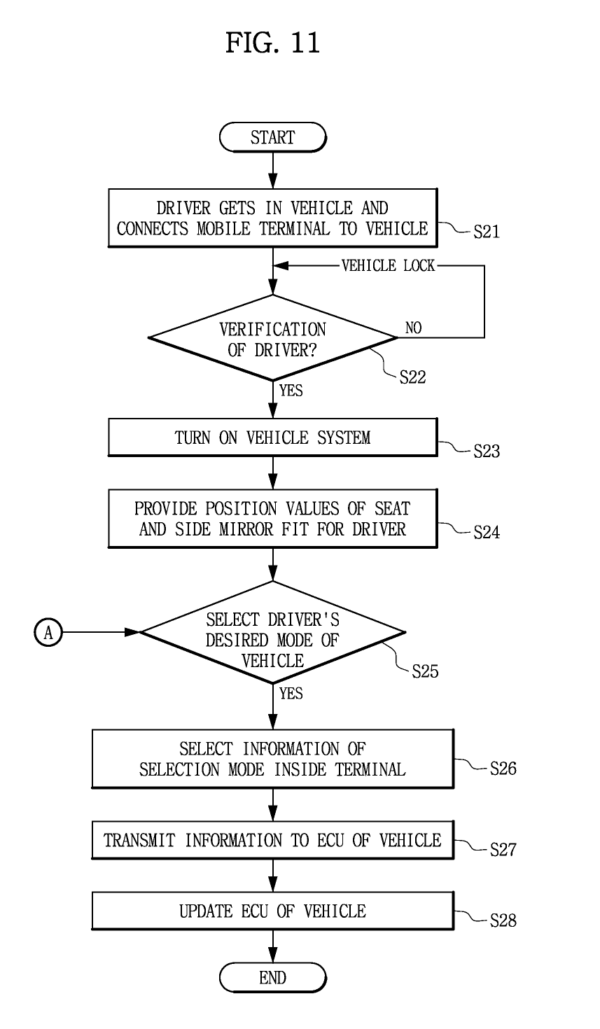

FIG. 11 is a flowchart illustrating a method for controlling the ECU according to an exemplary embodiment.

Referring to FIG. 11, the driver enters the vehicle and wirelessly or physically connects his or her mobile terminal to the vehicle (S21). The mobile terminal may be a smart phone capable of performing an internet communication; however, aspects of the mobile terminal are not limited hereto. The driver is identified and verified by information from the mobile terminal, such as a phone number or the like, or an input by the user (S22).

If the driver is not a proper driver based on the above verification, the vehicle system is locked, so that auto theft may be prevented. To the contrary, if the driver is a proper driver, the vehicle system may be capable of being turned on (S23).

If the vehicle system is turned on, the position values of the seat and the side minor corresponding to the driver's preference, may be provided to the ECU 20 by using the accumulated information of the driver (S24).

If the driver selects the desired vehicle mode (S25 and hereinafter, referred to as a point A), the information in accordance with the vehicle mode stored in the mobile terminal is selected (S26). The selected information is transmitted to the ECU 20 (S27), thereby causing the ECU 20 to be updated (S28).

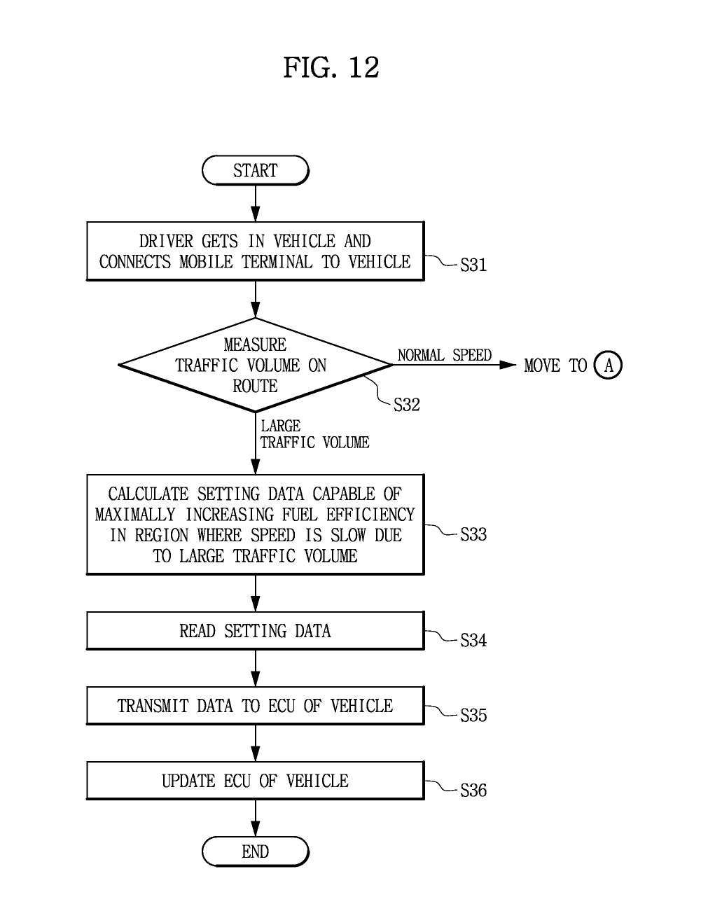

FIG. 12 is a flowchart illustrating a method for controlling the ECU according to an exemplary embodiment.

Referring to FIG. 12, a mobile terminal may be connected to a vehicle (S31). The mobile terminal measures the traffic volume on the route on the basis of status information collected (S32).

After the traffic volume is measured, the next operation may be performed by moving to the point A of FIG. 11. If a speed increase is prohibited due to traffic volume, a setting data capable of improving fuel efficiency to an optimal value may be calculated (S33).

The setting data is read (S34), and is transmitted to the ECU 20 (S35), thereby allowing the ECU 20 to be updated (S36).

The method of controlling the ECU of the vehicle described in FIG. 12 is an example related to the traffic volume on the route in the status information collected of the mobile terminal, where the status information for the time and the weather may be internally or externally collected, the status information accumulated and stored in the storage unit on the basis of the result, and the information is rearranged and calculated to be provided for the ECU 20.

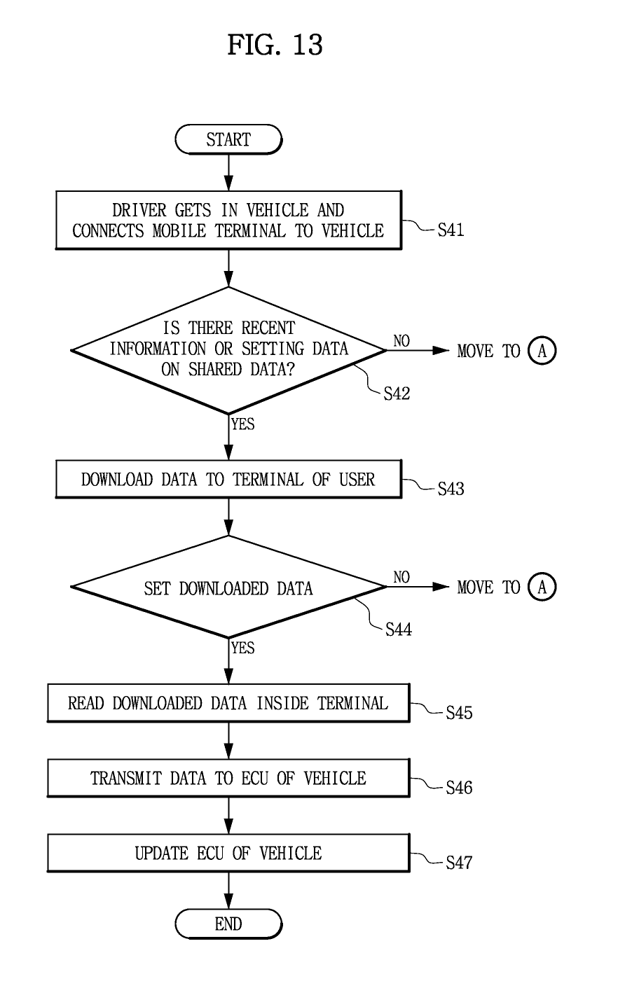

FIG. 13 is a flowchart illustrating a method for controlling the ECU according to an exemplary embodiment.

Referring to FIG. 13, a mobile terminal is connected to the vehicle (S41). The mobile terminal communicates with another device, for example, another mobile terminal or the external storage unit, to check whether recent information or recent setting data is part of shared data between the devices (S42).

After the shared data is checked, the operation correspond to point A of FIG. 11 may be performed. If there is recent information or recent setting data as part of the shared data, the user downloads the recent information or the recent setting data through the user's mobile terminal (S43).

The downloaded recent information or recent setting data may be set in the mobile terminal (S44), and the next operation corresponding to point A of FIG. 11 may be performed. The downloaded setting data is read (S45), and is transmitted to the ECU of the vehicle (S46), thereby causing ECU 20 to be updated (S47).

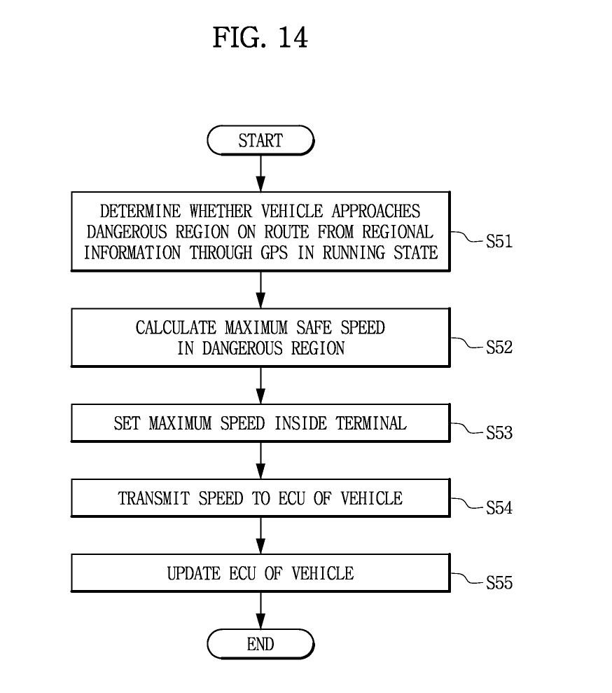

FIG. 14 is a flowchart illustrating a method for controlling the ECU according to an exemplary embodiment.

Referring to FIG. 14, if the vehicle approaches a dangerous region, such as a hazardous route due to road conditions or weather, on a route in which the vehicle is traveling, information is obtained on the basis of regional information using the GPS or the like (S51), the mobile terminal calculates the a maximum safe speed of the dangerous region (S52). The calculated maximum speed is set as the maximum speed (S53), and is transmitted to the ECU 20 (S54), thereby causing the ECU of the vehicle to be updated (S55).

As described above, according to the mobile terminal of the disclosure, the ECU 20, which may be correspond to a specific vehicle, is controlled by using information collected by the mobile terminal and/or user inputted information. Accordingly, it is possible to provide fuel efficiency and performance of the vehicle by mapping the ECU value of the vehicle to an optimal value based on satisfying a reference threshold in accordance with the driving environment or the characteristic of the driver.

Further, a plurality of drivers may share the information, such as optimal values associated with different modes and driving conditions. Moreover, it is possible to perform an auto theft prevention function, an emergency-time vehicle regulation function, and a black box function of a vehicle.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal to control an electronic control unit (ECU), comprising:
an ECU control unit to remotely control the ECU; and
a communication unit to communicate with the ECU;
wherein the ECU control unit controls the ECU based on a driving environment.

2. The mobile terminal according to claim 1, wherein the driving environment is based on at least one of: a road condition, a current weather status, a current time, a driver associated with the mobile terminal, current traffic volume, a slope of a stop region, an oxygen amount, and a detection of a dangerous region.

3. The mobile terminal according to claim 1, further comprising:
a storage unit to store information to operate the ECU,
wherein the ECU control unit controls the ECU based on the stored information.

4. The mobile terminal according to claim 3, wherein the ECU control unit calculates a factor to control the ECU based on the stored information updated by the driving environment.

5. The mobile terminal according to claim 2, further comprising:
a position ascertaining device to obtain position information of the mobile terminal,
wherein the driving environment is determined by the position information.

6. The mobile terminal according to claim 2, wherein the ECU control unit includes:
a selection section to select status information from a lookup table in accordance with the driving environment;
a rearrangement section to match the selected status information with collected information from the ECU; and
a calculation section to calculate setting data based on the matched selected status information with the collected information.

7. The mobile terminal according to claim 6, further comprising:
a communication unit to communicate with an external device or the ECU,
wherein the communication unit communicates the calculated setting data to the external device or the ECU.

8. The mobile terminal according to claim 1, wherein the ECU control unit includes:
a selection section to select status information in accordance with a current driving environment; and
a providing section to provide the selected status information to the ECU.

9. The mobile terminal according to claim 1, further comprising:
a sensor to sense an environmental condition associated with the mobile terminal,
wherein the driving environment is determined by the environmental condition.

10. A method for controlling an electronic control unit (ECU) from a mobile terminal, comprising:
determining a driving environment; and
remotely controlling the ECU from the mobile terminal based on the driving environment.

11. The method according to claim 10, wherein the driving environment is based on at least one of: a road condition, a current weather status, a current time, a driver associated with the mobile terminal, current traffic volume, a slope of a stop region, an oxygen amount, and a detection of a dangerous region.

12. The method according to claim 10, further comprising:
storing information to operate the ECU,
remotely controlling the ECU based on the stored information.

13. The method according to claim 13, further comprising calculating a factor to control the ECU based on the stored information updated by the driving environment.

14. The method according to claim 11, further comprising:
obtaining position information of the mobile terminal; and
determining the driving information by the position information.

15. The method according to claim 14, further comprising:
communicating with an external device; and
modifying the factor based on the communication with the external device.

16. The method according to claim 12, further comprising:
selecting status information in accordance with a current driving environment from the stored information;
matching the selected status information with information collected from the ECU; and
calculating a setting data mapped to the ECU on the basis of the matching.

17. The method according to claim 16, further comprising transmitting the calculated setting data to the ECU or an external device.

18. The method according to claim 10, further comprising:
sensing an environmental condition associated with the mobile terminal; and
determining the driving environment based on the environmental condition.

19. An electronic control unit (ECU) of a vehicle, the ECU comprising:
a central processing unit (CPU) to control the ECU; and
a communication unit to communicate remotely with a device that stores control information,
wherein the CPU controls the ECU based on the control information.

20. The unit according to claim 19, wherein:
the control information is based on at least one of: a road condition, a current weather status, a current time, and a driver associated with the device.
